(19) United States
(12) Patent Application Publication
(10) Pub. No.: US 2025/0150742 A1
(43) Pub. Date: May 8, 2025

(54) ELECTRONIC CHARGING DEVICE AND USER INTERFACE

(71) Applicant: Apple Inc., Cupertino, CA (US)

(72) Inventors: Darius A. Satongar, Staffordshire (GB); Per Haakan Linus Persson, San Francisco, CA (US); Thomas S. Hulbert, Sunnyvale, CA (US); William D. Lindmeier, San Francisco, CA (US)

(21) Appl. No.: 18/865,759

(22) PCT Filed: Jun. 13, 2023
(86) PCT No.: PCT/US2023/068386

§ 371 Date: Nov. 14, 2024

Related U.S. Application Data
(60) Provisional application No. 63/366,403, filed on Jun. 14, 2022.

(51) Int. Cl. H04R 1/10; G06F 3/04817; H04S 7/00

(52) U.S. Cl. CPC H04R 1/1041; G06F 3/04817; H04R 1/1025; H04S 7/30; H04R 2460/17

(57) ABSTRACT

An electronic device includes a housing defining an internal volume and an external surface. The electronic device can also include a cavity and a charging system disposed within the internal volume and electrically connected to the cavity. A user interface touchpad of the electronic device defines a portion of the exterior surface.

### CROSS-REFERENCE TO RELATED APPLICATION(S)

This application is a National Stage filing based off of PCT Application No. PCT/US2023/068386, filed 13 Jun. 2023, and entitled “ELECTRONIC CHARGING DEVICE AND USER INTERFACE” which claims priority to U.S. Provisional Patent Application No. 63/366,403, filed 14 Jun. 2022, and entitled “ELECTRONIC CHARGING DEVICE AND USER INTERFACE,” the entire disclosure of which is hereby incorporated by reference.

### FIELD

The described embodiments relate generally to electronic devices. More particularly, the present disclosure relates to electronic charging devices and user interfaces.

### BACKGROUND

Advances in portable computing have enabled wearable devices, such as wireless headphones, to be wirelessly connected to one or more other electronic devices. Audio outputs from these other electronic devices can be listened to by the user through the headphones. Wireless headphones are generally small and lightweight so that the user can conveniently wear the headphones in or on the user's ears without hassle. However, the small form factor of headphones can limit the space that is available on the headphone to incorporate user input features and audio control functionalities.

Therefore, there is a need to design devices, systems, and methods to increase the user input and control functionalities of wireless headphones and associated devices.

### SUMMARY

The present disclosure relates to electronic devices. In particular, the present disclosure relates to electronic devices having user interface features.

According to one example of the present disclosure, an electronic device includes a housing having a cavity configured to receive an earbud, an input device configured to generate a signal in response to detecting a user input, and circuitry coupled to the input device. The circuitry can be configured to detect the signal and, in response to detecting the signal, send an instruction to the earbud to change at least one of a source or a perceived location of audio content output at the earbud.

In one example, the input device can be further configured to generate a graphical user interface. In one example, the graphical user interface includes a user selectable icon corresponding to an audio source and the audio source includes at least one of a music application, a calendar application, an email application, a message application, or a weather application. In one example, the input device can include a capacitive touch surface. In one example, the user input can include a gesture applied in a direction along the capacitive touch surface. In one example, in response to detecting the signal, the input device sends an instruction to the earbud to change the perceived location of audio content output at the earbud and the direction corresponds to a perceived source location of the audio content. In one example, the instruction changes the perceived source location.

In one example of the present disclosure, an electronic system includes a case defining an external surface and including a cavity configured to receive an electronic device and a display device. The display device is configured to generate a first user interface at the external surface and in response to detecting a user input at the external surface, generate a second user interface.

In one example, the first user interface includes a graphical user interface. In one example, the first user interface includes an audio user interface. In one example, the first user interface include a virtual user interface. In one example, the case includes a capacitive touch surface at least partially defining a user interface region of the external surface and the electronic device includes an earbud. In one example, the user input includes a gesture input. In one example, the gesture input includes a touch input at the capacitive touch surface. In one example, the touch input contacts the capacitive touch surface at a location corresponding to a user selectable icon of the first user interface and the second user interface includes a second user selectable icon.

In one example of the present disclosure, a head mountable display can include a processor, memory, and a program stored in the memory, the program including instructions which, when executed by the processor, cause the head mountable display to display a virtual user interface on an external surface of a housing of an electronic device defining a cavity, detect a user input at the external surface while displaying the virtual user interface, and in response to detecting the input, alter the virtual user interface.

In one example, the virtual user interface corresponds virtually to a user interface region defined by the external surface of the electronic device. In one example, the user interface region of the external surface includes a capacitive touch surface. In one example, displaying the virtual user interface includes displaying a first user selectable icon and altering the virtual user interface includes displaying a second user selectable icon. In one example, the cavity is shaped to receive an earbud.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic view of an electronic device;

FIG. 2A shows a schematic view of an electronic device system;

FIG. 2B shows a schematic view of an electronic device system;

FIG. 3 shows a schematic view of an electronic device and associated user interface region;

FIG. 4 shows a schematic view of an electronic device;

FIG. 5 shows a schematic view of an electronic device;

FIG. 6 shows a schematic view of a user using an electronic device system, including an earbud charging case and earbuds;

FIG. 7 shows a schematic view of an electronic device, including a user interface region and various output features;

FIG. 8 shows a schematic view of an electronic device having a user interface region;

FIG. 9A shows a schematic view of an electronic device having a user interface region;

FIG. 9B shows a side view of a device according to the device shown in the schematic view of FIG. 9A;

FIG. 10 shows a schematic view of an electronic device having a user interface region;

FIG. 11 shows a schematic view of an electronic device having a user interface region;

FIG. 12 shows a schematic view of an electronic device having a user interface region;

FIG. 13 shows a schematic view of an electronic device having a user interface region;

FIG. 14 shows a user using an electronic device such as an earbud charging case in proximity with other electronic devices;

FIG. 15A shows a spatial audio representation of audio content received by a user through earbuds;

FIG. 15B shows a spatial audio representation of audio content received by a user through earbuds;

FIG. 15C shows a spatial audio representation of audio content received by a user through earbuds;

FIG. 15D shows a spatial audio representation of audio content received by a user through earbuds;

FIG. 16A shows an electronic device such as an earbud charging case included in an AR/VR system; and

FIG. 16B shows a perceived input area as seen through an AR/VR system.

### DETAILED DESCRIPTION

Reference will be made in detail below to representative embodiments and examples illustrated in the accompanying drawings. However, the following descriptions are not intended to limit the embodiments to one preferred embodiment. Rather, it is intended to cover alternatives, modifications, and equivalents as can be included within the spirit and scope of the described embodiments as defined by the appended claims.

The present disclosure relates to electronic devices. In particular, the present disclosure relates to electronic charging devices having user interface features. In one example, the present disclosure includes an electronic charging device having a housing that defines an internal volume and an external surface. The electronic device can also include a cavity and a charging system disposed within the internal volume and electrically connected to the cavity. In one example, the electronic device also includes a user interface region, which in some examples can include a touchpad defining a portion of the exterior surface. In some example, the housing can form the user interface region.

In such an example, the electronic charging device can be a charging case for wireless headphones, also referred to herein as earbuds. Charging cases can be used to store and charge earbuds when one or more of the earbuds are not in use. During use, the earbuds can be removed from the charging case and placed in or on the user's cars to listen to audio. In one example, the charging case itself can facilitate a wireless connection between the earbuds and one or more other devices streaming or transmitting the audio. The user can remove the earbuds and place them back into the charging case when the earbuds are running low on power or when the user is done using the earbuds.

Some earbuds can include user input components, such as buttons or capacitive touch sensors that enable the user to control the audio being listened to at the point of the earbud itself. For example, an earbud may include a capacitive touch sensor that registers a tapping or pressing of the earbud by the user's hand/or finger. Various combinations of taps or touches of the earbuds themselves can cause the audio input to pause, increase or decrease in volume, turn on, turn off, or the like. Earbuds and other wireless headphones may be designed with small form factors that enable the user to wear the earbuds conveniently and comfortably. However, this small form factor limits the available space, such as the surface area of the earbuds themselves, to include control input capabilities or other user interface features.

Advantageously, the user interface region of a charging case described herein can be utilized by the user to input control commands for controlling the earbuds or the audio being transmitted thereto. Such a user interface region, located with the charging case of the earbuds, provides increased surface area or space, in place of or in addition to that of the earbuds themselves, to include sensors, buttons, or other interface components that expand user input capabilities, user interface outputs, and control functionalities.

For example, at least some of the user interface regions of electronic charging devices and input devices described herein can include one or more capacitive touch surfaces configured to receive gesture controls from the user. For example, while wearing the earbuds and listening to audio content, a user can swipe a finger on the user interface region of the charging case in a certain direction, motion path, or for a certain duration, to indicate any number of controls to manipulate the audio being listened to through the earbuds. In one example, a user can swipe left or right to move back and forth from one track of audio to another. In another example, a user can swipe a finger in a circular motion on the user interface region to indicate a volume change. The surface area provided by the user interface region s described herein can thus receive user touch gestures as command inputs to control audio content output by the earbuds. As used herein, the terms “gesture,” “contact gesture,” “touch gesture,” or other terms including “gesture,” can include any path, motion, or contact profile of the user's finger as it contacts the user interface region. Gestures can include the direction, shape, duration, pressing force, or other contact characteristics between the user's finger or hand and the user interface region. For example, gestures can include swipe paths in any direction, shapes such as circles, triangles, rectangles or other shapes, taps, hard or soft presses, or any combination thereof, as formed by the path of the finger along the region and as detected by the region.

The foregoing examples of gesture controls and their effects on the audio being listened to through the earbuds are given as non-limiting examples only. One will appreciate that the user interface region of the electronic charging and input devices described herein can be configured to register any gesture of any path, direction, shape, or combination thereof. The larger surface area of the charging case provides increased resolution for more complicated and varied user input gestures associated commands. In general, the user interface features of electronic charging and other input devices described herein, including user interface regions and touchpads, expand the available surface area that can be used to receive user control inputs, which in turn expands the number and variety of controls and user inputs available to the user beyond what may be available on just the earbuds themselves.

In addition to the expanded control functionalities described above, the electronic charging and input devices described herein reduce the frequency of interaction between the user's hands or fingers and the earbuds themselves. Examples of electronic input devices described herein can provide a more convenient point of interaction for the user as he or she controls the audio output of the earbuds. For example, an electronic charging input device can be configured to be placed in a user's hand/or pocket such that the user can touch the charging device near where the user's hands may be positioned at rest in order to control the audio output or other functions of the earbuds. In this way, the user does not need to repeatedly reach up to his or her ears, where the earbuds are located, to control the audio output.

Electronic input devices described herein, such as earbud charging cases, can be used to provide expanded user output functionalities of audio devices such as earbuds. For example, electronic input devices of the present disclosure can include visual, audio, or tactile outputs to relay information to the user.

In addition, in at least one example, electronic input devices described herein can include additional components such as processors, memory components, antennas, proximity sensors, or other components that expand the earbud control functionalities and features. Such components can enable electronic input devices to communicate with one or more other electronic devices, such as other computing devices that include audio outputs. Electronic input devices of the present disclosure can be configured to advantageously control which device is connected to the earbuds such that a user can seamlessly switch from receiving the audio output of one device to receiving the audio output from another.

Current wireless headphones on the market may generally be considered as accessories to other devices to which they connect. For example, wireless headphones may be considered an accessory product to a mobile phone where the headphones have limited capacity for receiving audio controls. That is, in many instances, the audio streamed to the headphones by the mobile phone is still largely controlled using the user interface of the phone. Thus, use of the earpieces themselves are at least partially dependent on the mobile phone and, in this way, can be considered an accessory item. However, wireless earpieces, such as the earbuds and charging cases described herein, can be configured as standalone electronic devices utilizing input and control interfaces at the case itself. In this way, in at least some examples, the audio devices and systems described herein can be used to create an immersive lifestyle device, which can include music streaming, message and calendar notifications, driving directions, and the like, without being dependent or accessory to another device.

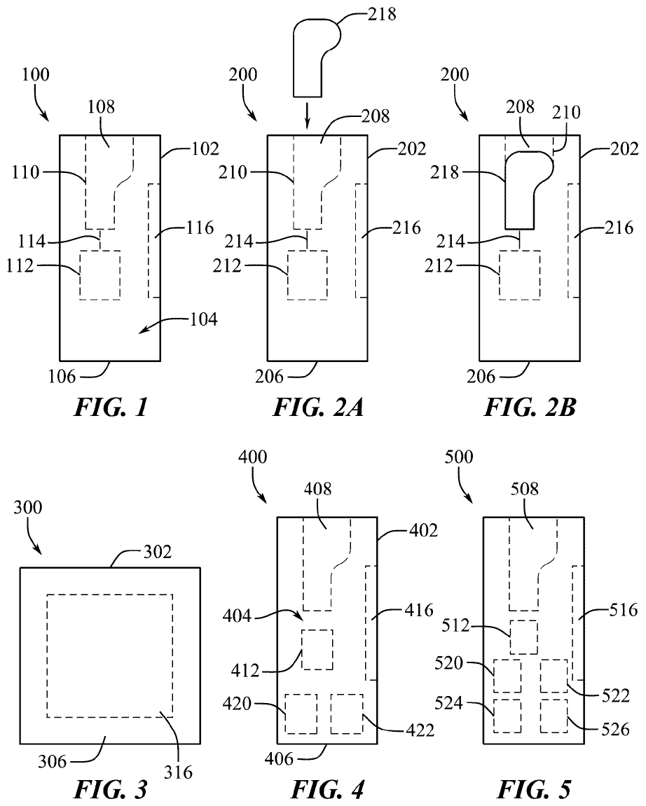

These and other embodiments are discussed below with reference to FIGS. 1-15. However, those skilled in the art will readily appreciate that the detailed description given herein with respect to these FIGS. is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

Turning now to the FIGS., FIG. 1 illustrates a schematic view of an electronic input device 100, otherwise referred to herein as device 100. In at least one example, device 100 includes a housing 102 that at least partially defines an internal volume 104 and an external surface 106. In addition, at least one example of device 100 includes a cavity 108. Cavity 108 can be disposed with in the internal volume 104 and can be at least partially defined by one or more interior housing surfaces 110. In the example of FIG. 1, device 100 also includes a charging system 112 disposed within internal volume 104. Charging system 112 can be electrically connected to the cavity 110, via one or more electrical connections, such as wires or other charging circuitry 114.

In at least one example, device 100 includes a user interface region 116 that defines at least a portion of the exterior surface 106. In at least one example, housing 102 can define at least a portion of user interface region 116. User interface region 116 can take many forms and is generally configured to receive a contact input when contact is made at outer surface 106 of device 100 defined by user interface region 116. In one example, user interface regions 116 includes a touchpad, such as a capacitive touchpad having a surface area that at least partially defines exterior surface 106.

In at least one example, charging system 112 can be configured to deliver electrical current to cavity 108 such that electrical current is carried to one or more interior housing surfaces 110 defining cavity 108. In this way, an object received into cavity 108 and making contact with internal housing surface 110 electrically connected to charging system 112 can be charged. For example, as shown in FIGS. 2A and 2B, a device 200 includes a cavity 208 configured to receive an earbud 218. FIG. 2A illustrates earbud 218 separate from device 200 with an arrow indicating that earbud 218 can be inserted into cavity 208. As shown in FIG. 2B, earbud 218 can be received with in cavity 208 such that earbud 218 makes contact with at least a portion of one or more interior housing surfaces 210 defining cavity 208. In this way, when earbud 218 is received into cavity 208, charging system 212 can deliver electrical current via charging circuitry 214 to earbud 218, which is in contact with interior housing surfaces 210 to which electrical current is being delivered by charging system 212 and charging circuitry 214.

Earbud 218 can include one or more internal batteries (not shown) that power earbud 218 when the user removes earbud 218 from cavity 208 of device 200 and places earbud 218 on or in his or her ear to listen to audio output from earbud 218. When the user is finished using earbud 218 or when the one or more batteries of earbud 218 are running low on power, the user can insert earbud 218 into cavity 208 of device 200, as shown in FIG. 2B, to recharge the one or more batteries of earbud 218. In addition, at least one example of charging system 212 of device 200 includes a battery. The battery of a charging system 212 can be recharged using external electrical power and can be configured to deliver current through charging circuitry 214 to cavity 208, and thus, to earbud 218 for recharging.

Device 200 shown in FIGS. 2A and 2B also includes a user interface region 216 that at least partially defines an exterior surface 206 of a housing 202. The components and features of the devices 100 and 200 shown in FIGS. 1, 2A, and 2B, can be included alone or in any combination in any other devices described herein. In addition, features and components of devices described with reference to other figures can be incorporated individually or in any combination with in devices 100 and 200 shown in FIGS. 1, 2A, and 2B.

FIG. 3 illustrates a schematic view of a device 300 that includes a housing 300 and defining at least a portion of an exterior surface 306. Device 300 also includes a user interface region 316, which can also define at least a portion of exterior surface 306. The size, shape, and position of user interface region 316 can vary in one or more other examples. In general, user interface region 316 can provide an amount of surface area available for receiving touch commands from the user that is greater than what is available from an earbud, such as earbud 218 shown in FIGS. 2A and 2B. That is, user interface region 316 can define an area of external surface 306 to receive a user's touch input such as touch gestures and swiping contacts that can extend across, or anywhere within, the area designated by user interface region 316.

Accordingly, in at least one example, user interface region 316 includes one or more sensors, for example touch sensors. Device 300 can include circuitry coupled to device 330 or to a processor of device 300 that can be electrically connected to the one or more sensors of user interface region 316 such that the position and changes in position of a user's touch, for example when a user taps, swipes, or otherwise gestures while contacting user interface region 316, can be detected and identified.

In the illustrated schematic of FIG. 3, user interface region 316 is shown as a generally square or rectangular area centrally disposed on housing 302 of device 300. This configuration of user interface region 316 is one exemplary configuration, and other examples can include two or more user interface regions 316 at least partially defining exterior surface 306, with each of the multiple user interface regions having different shapes, sizes, or locations from that shown in FIG. 3. During use, the user can handle device 300 via housing 302 and touch user interface region 316 using one or more fingers, for example, by tapping, swiping, or otherwise gesturing on the area of external surface 306 defined by user interface region 316. Such gesture contact from a user's hand/or fingers can be received and interpreted as various audio control input commands by device 300.

Accordingly, in at least one example, user interface region 316 includes a capacitive touch surface that defines at least a portion of the exterior surface 306 of device 300. In one example, such a touch surface can be a distinct component separate from other portions of housing 302, but defining a portion of exterior surface 306 along with the rest of housing 302. Alternatively, such a capacitive touch surface of user interface region 316 can be defined by housing 302 such that a defined portion of housing 102 acts to receive a touch input. In this way, housing 302 can form a dielectric layer or plate of a capacitive sensor stack.

Along these lines, user interface region 316 can include multiple components, including multiple layers, configured to sense a change in capacitance of one or more of the layers when the user contacts the portion of exterior surface 306 of housing 302 that corresponds to user interface region 316. In one example, housing 302 forms a dielectric layer disposed between the user's skin/finger during contact with user interface region 316 and one or more conductive layers disposed inwardly from exterior surface 306 of housing 302, for example, within internal volume 304. Such layers can be configured to hold an electric charge. In one example, such an inner conductive layer of a capacitive touch sensor stack forming user interface region 316 can include one or more conductive plate or electrode. Sensing circuitry can electrically connect such an electrically conductive layer with one or more processors within device 300. The processor can be configured to determine a change in the charge of the internal conductive layer. This change in electrical charge can occur when a user's finger comes near to or contacts user interface region 316 at exterior surface 306 of housing 302, with the user's finger acting as an opposing charged object to be sensed.

In one or more other examples, user interface region 316 can include one or more other types of touch sensors and components thereof. For example, user interface region 316 can include one or more pressure sensors and components thereof, one or more resistive touch sensors and components thereof, or other touch sensor configurations and components thereof.

Additionally, or alternatively, one or more examples of user interface regions 316 described herein can include one or more depressible buttons defining a portion of housing 302. For example, user interface region 316 can include one or more buttons that can be depressed below a level or plane defined by exterior surface 306 of housing 302. In this way, user interface region 316 can include tactile feedback from the physical depression of a button while inputting audio control command, such as gestures, with his or her fingers or hands at device 300. At least one example of device 300 can include a combination of one or more depressible buttons and/or one or more areas defining user interface region 316, such as the capacitive sensor touchpads described herein.

All of the features and components, or combinations thereof, described with reference to device 300 shown in FIG. 3 can be incorporated individually or in any combination with other devices described herein, with reference to other figures. In addition, those features and components of devices shown and described with reference to other figures can be included individually or in combination with device 300 shown in FIG. 3.

FIG. 4 illustrates another example of a device 400 having a cavity 408 configured to receive an earbud. Device 400 also includes a housing 402 defining an exterior surface 406 with a user interface region 416 also defining a portion of exterior surface 406. As shown, device 400 also includes a charging system 412 configured to electrically charge an earbud received into cavity 408. In addition, at least one example of device 400 includes a processor 420 and an antenna 422. In at least one example, processor 420 and antenna 422 are disposed within internal volume 404 of device 400. In addition, device 400 can also include circuitry connecting the antenna 422 to processor 420.

One or more other examples of device 400 can include two or more processors 420 and/or two or more antennas 422 disposed at various locations within internal volume 404. In at least one example, antenna 422 is configured to transmit and receive electromagnetic signals to and from device 400. For example, antenna 422 can be configured to send electromagnetic signals to one or more earbuds separated from device 400 and being used by a user. Also, for example, antenna 422 can be configured to send and receive signals between device 400 or earbuds and other electronic devices, such as a mobile phone or other computing device that may transmit audio signals or content to the earbuds. In response to detecting or sending one or more electromagnetic signals, device 400 can send an instruction to the earbuds or other electronic devices.

Processor 420 can be electrically coupled to a user interface region 416 and antenna 422 via circuitry. Processor 420 can be configured to cause antenna 422, via the circuitry, to send and receive signals to various other devices, including one or more earbuds that are configured to be received into cavity 408, based on user inputs received by user interface region 416. A user can input a command via the user interface region 416, for example, by tapping, gesturing, swiping, or otherwise contacting user interface region 416, such that the command indicates an intended action of device 400. For example, a certain gesture inputs at user interface region 416 can indicate that the user wants to skip from one song being listened to through an earbud to the next song. Processor 420 can be configured to recognize the input command and cause antenna 422 to send one or more signals communicating with device 400 or associated earbuds, such as a mobile phone, from which the earbud is streaming music. As another example, the user can input the gesture or other touch command at user interface region 416 to indicate an intent to start or stop the audio content transmitted to the earbuds. Processor 420 can be configured to recognize any variety of such commands at user interface region 416 and cause antenna 422 or any other component of device 400 to carry out the action or function desired by the user.

One will appreciate that any number of contact gestures, swipes, taps, or other touch commands input by the user at user interface region 416 can be recognized by processor 420. Processor 420 can thus be configured to carry out any such command that is input at user interface region 416 by the user. Carrying out such a command can include causing antenna 422 to send or receive signals with one or more other devices or causing one or more other components of device 400 to carry out the command. Other commands that can be input by the user include, as non-limiting examples, skipping audio tracks, speeding up or slowing down audio inputs, switching from one audio stream to another, connecting or switching to or from various other devices providing audio streams, increasing or decreasing volume, or any other audio control command.

Antenna 422 can include one or more components configured to send and receive electromagnetic signals, including digital audio content signals and the like. For example, antenna 422 can include multiple antenna modules including Bluetooth modules and circuitry, ultra-wideband stacks, or other transmitter-receiver modules or combinations thereof.

All of the features and components, or combinations thereof, described with reference to device 400 shown in FIG. 4, can be incorporated individually or in any combination with other devices described with reference to other figures. In addition, those features and components of devices shown and described with reference to other figures can be included individually or in combination with device 400 shown in FIG. 4.

FIG. 5 illustrates a schematic view of another example of a device 500 that includes a cavity 508 configured to receive one or more earbuds, a user interface region 516, a charging system 512, a processor 520, and an antenna 522. In at least one example, circuitry can be coupled to device 500 that electrically connects antenna 522 and processor 520. In addition, at least one example of device 500 can include one or more memory components 524 or one or more proximity sensors 526. Processor 520 can also be electrically connected with or otherwise in electrical communication with memory component 524 and proximity sensor 526. Device 500 having memory component 524 can be configured to store data, such as audio content or other data associated with mobile device applications, such as messaging data, e-mail data, audio content libraries including music and other audio tracks, and the like. In this way, device 500 can access content at memory component 54 and stream the content to earbuds via the processor 520 causing antenna 522 to transmit data from device 502 to one or more earbuds being used by the user.

Advantageously, device 500 including memory component 524 can be used as a stand-alone audio content device for streaming audio content to the user via earbuds without connecting to, or being accessory to, other devices such as phones, computers, digital music players, and the like. For example, the audio can be downloaded and stored directly onto memory component 524 of device 500, and processor 520 can be configured to stream content stored on a memory component 524 to one or more earbuds via antenna 522 or other components. In such an example, user interface region 516 can be used to control content from memory component 524, as it is transmitted to the earbuds.

The components and features of device 500 shown in FIG. 5, such as memory component 524 and proximity sensor 526 can be included in any of the devices described herein with reference to other figures. In addition, features and components of other devices described herein with reference to other figures can be included, individually or in combination with one another, with device 500 described with reference to FIG. 5.

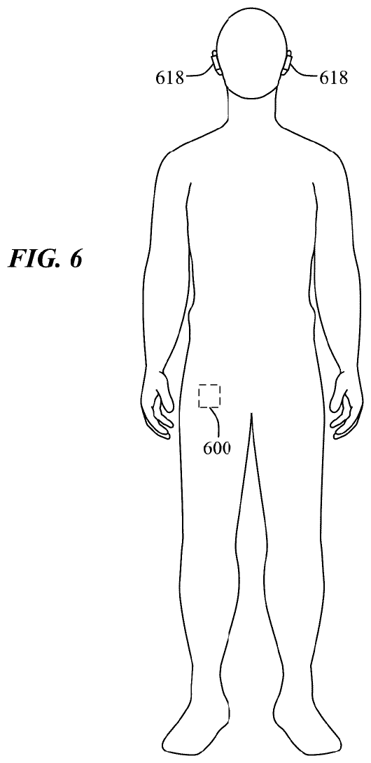

FIG. 6 shows a user with device 602 disposed in the user's pant pocket and one or more earbuds 618 disposed at or on the user's ears. As noted above, device 600 can be configured in size and shape to be conveniently placed in a pocket, as shown, or in any other clothing pocket, purse, or bag donned by the user. In some examples, the user may choose to hold device 600 in his or her hand during use. Advantageously, the user can choose to hold or store device 600 most conveniently to have quick access to the user interface region of device 600 for easy control of the audio streamed to earbuds 618. Also, as noted herein, device 600 can include a memory component from which device 600 can stream audio content to earbuds 618 without any wireless connection or other connection to another device such as a mobile phone. In other examples, the user can also carry one or more mobile or wearable computing devices such as mobile phones, electronic watches, or tablet and laptop computers that are connected wirelessly to earbuds 618 and/or device 600. In such examples, device 600 can be configured to connect earbuds 618 to one or more of the other devices so that the one or more other devices can transmit audio content to earbuds 618. In some examples, as noted herein, device 600 can include one or more antennas configured to transmit audio content to earbuds 618 from device 600 itself.

As noted above, device 600 can be a charging case for earbuds 618. That is, in addition to the other features and functionalities of device 600 described above, device 600, or charging case 600, can include one or more cavities for receiving earbuds 618 and a charging system configured to charge or recharge one or more batteries of earbuds 618. Advantageously, the charging functionality of device 600 can be combined with the other control features, components, and functionalities described herein, for example user interface regions, processors, circuitry, antennas, memory components, proximity sensors, and so forth, in one simple and compact device.

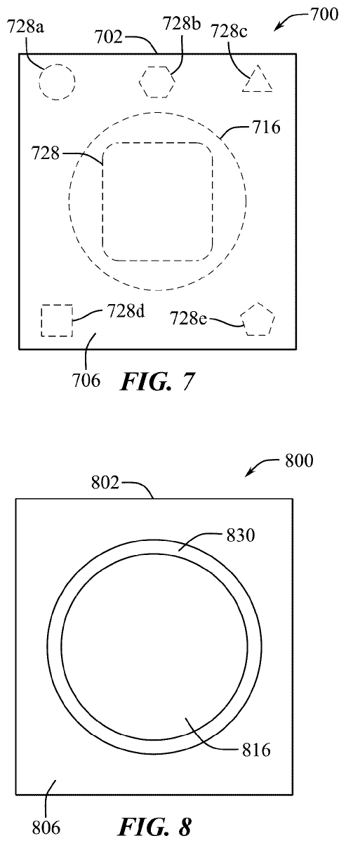

In addition, as the user interacts with device 600 to control the audio output of the earbuds 618, device 600 and other devices described herein can include one or more output features to communicate information to the user. That is, in addition to the user interface regions described herein, which are configured to receive command inputs from the user, one or more examples of devices of the present disclosure can include user interface output features and components. For example, FIG. 7 shows a schematic view of device 700 that includes housing 702 defining exterior surface 706, user interface region 716, and one or more output features 728. Output features 728 are shown in dotted lines to indicate that the number, size, shape, and position of each output feature 728 can vary from one example to the next. FIG. 7 shows some examples of output feature locations on exterior surface 706 of device 700. In addition, for exemplary purposes only, output features 728 are shown as generally rectangular or circular in shape. The dotted lines indicating output features 728 in FIG. 7 are provided as general examples of where one or more output features may be located on device 700.

In one example, one or more output feature 728 can include a visual icon, such as a light or backlit image that can turn on or off to relay information to the user. For example, one output feature 728 can include a backlit form of an envelope that indicates an e-mail notification to the user. Once indicated by the output feature 728, the user can input touch commands at user interface region 716 so that a processor of device 700 can cause an audio output of the mail notification or mail contents to be streamed to the earbuds. In the foregoing example of an e-mail notification, one or more components of device 700, such as antennas or other transmitters and receivers of devices described herein, can relay audio output from an e-mail message or notification from a separate connected device such as a mobile phone or computer.

One or more output features 728 can include other visual or tactile outputs to notify the user of various other notifications, statuses of device 700, or other information. For example, one or more output features 728 can alert the user with visual icons representing text messages received, upcoming calendar events, missed calls from a connected mobile phone, or any other information relayed to device 700 from other connected electronic devices. Output feature 728 can also include one or more light indicators without specific forms of images. As shown, at least one output feature can utilize and area of external surface 706 occupied by user interface region 716. For example, output feature 728 located at user interface region 716 can include a diffuse backlit portion of exterior surface 706. In addition, any of the lit output features 728 of device 700 can include multiple colors that could indicate unique meaning to the user.

In response to receiving information from output features 728, the user can swipe or otherwise gesture on the user interface region 716 of housing 702 to change the audio outputs of the earbuds based on information relayed by the output features 728. Using the mail envelope example from above, which may indicate an incoming e-mail message to the user, a user can then touch or swipe on the user interface region 716 in a certain way that causes a processor of device 700 to switch the audio being transmitted to the earbuds to an audio reading of the contents of the e-mail. For example, the user could make a swiping gesture with his or her finger on user interface region 716 with the direction of the swipe or gesture aimed at the given output feature 728. In this way, the user can indicate which output feature 728 he or she is interested in, and can switch the audio output by the earbuds accordingly. This is one example of an interaction between the user and device 700 that includes one or more output features 728 relaying information to the user, and the user subsequently reacting to that information by inputting controls via device 700 to manipulate the content of audio received through wirelessly connected earbuds.

One will appreciate that any number of output features 728 or combinations of output features 728 can communicate any number of notifications, statuses, or other information to the user. Other interactions between device 700 and the user can include output features 728 indicating traffic directions. Accordingly, if the user is listening to music via earbuds is wirelessly connected to device 700, one or more output features 728 can indicate to the user that he or she needs to listen to an upcoming traffic navigation instruction. In reaction, the user can swipe or gesture on the user interface region 716 in such a way that device 700 then interrupts the music with the navigation instruction audio output at the earbuds. The same process can occur with output features 728 indicating text messages, weather conditions and forecasts, news headlines, stock price updates, missed calls from a mobile phone, or any other piece of information that can be relayed by audio to the earbuds.

In addition to, or alternatively to, output features 728 of device 700 described herein, device 700 can include one or more haptic output features or components for interfacing with the user and conveying non-audio information from device 700 in a tactile manner. For example, device 700 can include a motor or other vibration producing component that can vibrate device 700 to alert the user of a status change, notification, or other output information, as described above. Vibrational or other tactile feedback mechanisms can be configured to provide unique movements or vibrations of device 700, each conveying unique information to the user.

The components and features of device 700 shown in FIG. 7, such as the various output feature 728 and configuration of user interface region 716, can be included in any of the devices described herein with reference to other figures. In addition, features and components of other devices described herein with reference to other figures can be included, individually or in combination with one another, with device 700 described with reference to FIG. 7.

FIGS. 8-13 show schematic views of various examples of user interface regions, which can be implemented alone or in combination with one another in any of the devices described in the present disclosure. For example, FIG. 8 shows a schematic view of device 800, which can include any or all of the features and components of other devices described herein with reference to other figures. For example, device 800 can be configured as a charging case for earbuds. In one example, user interface region 816 can be generally circular and can be disposed centrally on the exterior surface 806 of device 800. In at least one example, user interface region 816 can include a capacitive touchpad surface or sensor.

In the illustrated example of FIG. 8, the touchpad or housing 802 forming user interface region 816 can be raised or lowered to define a different plane from the plane or planes defined by the rest of the housing 802 that defines exterior surface 806. A transition surface 830 can form a portion of exterior surface 806 extending between the user interface region 816 and the rest of housing 802. For example, transition surface 830 can slant upward from housing 802 to user interface region 816 in examples where user interface region 816 includes a raised surface. Likewise, transition surface 830 can slant downward towards user interface region 816 in examples where user interface region 816 is recessed below the rest of housing 802. Alternatively, in examples where user interface region 816 is generally level with, or shares a plane with, the rest of housing 802, transition surface 830 can form a channel or ridge.

In any case, transition surface 830 can serve to provide a physical feature that indicates to a user where the bounds or outer perimeter of user interface region 816 is located. In this way, if a user stores device 800 out of sight within a pocket or purse, as shown in FIG. 6, a user can blindly feel for and can locate user interface region 816 on device 800.

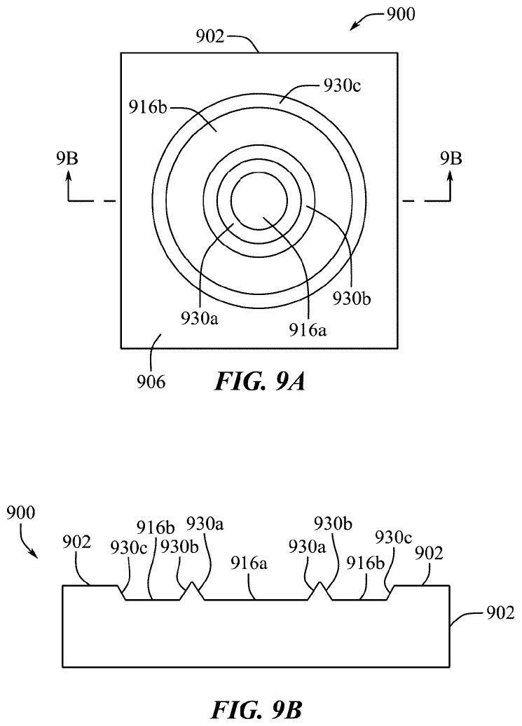

FIG. 9A shows another example of a device 900, such as a charging case for wireless earbuds. FIG. 9A shows a schematic view of device 900, which can include any or all of the features and components of other devices described herein with reference to other figures. FIG. 9B illustrates a side view of an embodiment of device 900 according to the schematic view of FIG. 9A. In the illustrated example of FIG. 9A, device 900 includes two distinct user interface regions 916a, 916b, with an inner user interface region 916a disposed centrally and concentrically with outer user interface region 916b. Again, user interface regions 916a and 916b can include one or more sensors, touchpad surfaces, or other forms of user interface regions defined herein. Transition surfaces 930a, 930b, 930c can be disposed to transition between user interface regions 916a, 916b and exterior surface 906 of housing 902. Transition surfaces 930a and 930b can form a ridge or valley transitioning between the two user interface regions 916a, 916b. In this way, the user can tactically feel the difference between the two user interface regions 916a, 916b without a visual verification of where the user's finger or hand makes contact with device 900.

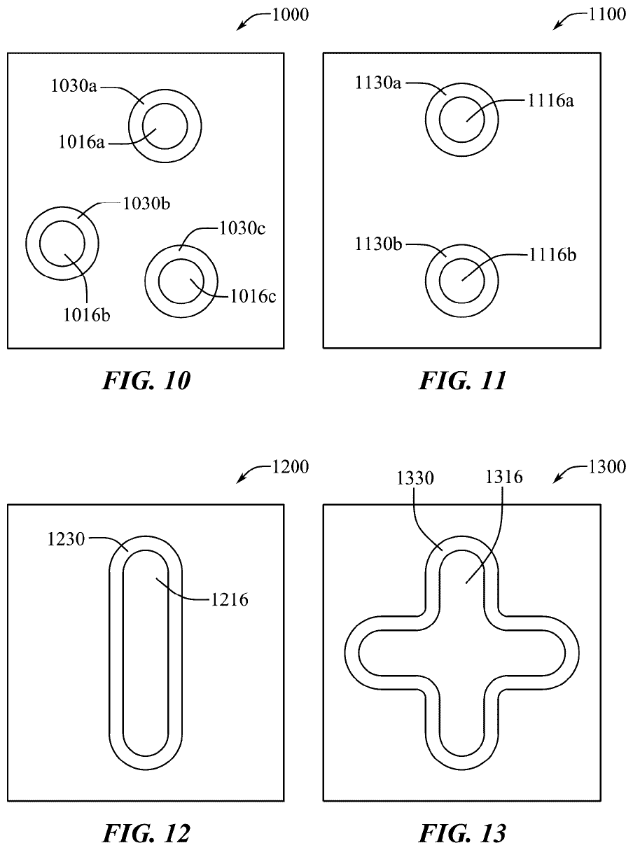

FIG. 10 shows a schematic view of device 1000, which can include any or all of the features and components of other devices described herein with reference to other figures. For example, device 1000 can be configured as a charging case for earbuds. In the illustrated example of FIG. 10, device 1000 can include three distinct user interface regions 1016a, 1016b, 1016c with corresponding transition surfaces 1030a, 1030b, and 1030c. The arrangement, configuration, and number of different user interface regions can vary from one example to another. Each user interface region 1030a-c can be used separately for unique commands received through gestures, swipes, touches, taps, and so forth, as described herein.

Another example of a charging case having one or more user interface regions incorporated onto an exterior surface thereof is shown in FIG. 11. FIG. 11 shows a schematic view of device 1100, which can include any or all of the features and components of other devices described herein with reference to other figures. FIG. 11 shows two separate and circular user interface regions 1116a, 1116b with corresponding transition surfaces, 1130a, 1130b, respectively.

FIGS. 12 and 13 show schematic views of other examples of a devices 1200, 1300 which can include any or all of the features and components of other devices described herein with reference to other figures. Device 1200 includes a single user interface region 1216 centrally disposed on device 1200 and forming an elongate shape or bar. Device 1300 of FIG. 13 includes a single user interface region 1316 in the shape of a cross having multiple extensions surrounding a central portion thereof.

One will appreciate from the foregoing examples of devices shown in FIGS. 8-13 that any size, shape, location, or configuration of one, two, or more than two user interface regions can be incorporated onto a device, such as an earbud charging case, to form a portion of an exterior surface of the charging case. Each configuration shown can receive touch gesture commands from the finger or hand of the user, including swipes, taps, or any other gesture paths from the user's finger. As used herein, the terms “gesture,” “gesture command,” “gesture touch,” or other related terms, can refer to the detected motion and position of a user's touch, for example a physical contact from the user's finger on the devices described herein, on or at the user interface regions of the devices. Gestures can be input by users by touching the user interface region of a device or by touching and moving a finger or other body part in a certain path along the external surface of the device corresponding to the user interface region. Some gestures can include the path or shape of the continuous moving touch of the user. Some gestures can include single taps or touches without moving from a certain location. Some gestures can include multiple taps or a combination of one or more single touches/taps and one or more movements or paths/shapes created by the touch of the user. As such, the user interface regions of devices described herein include a surface area large enough to accommodate such gestures.

One or more processors of the devices shown can cause one or more other components of the devices to transmit or receive various commands to and from wirelessly connected earbuds or other devices to control the audio output of the earbuds being used. In each of the features or components of devices shown in FIGS. 8-13 can be included with any other device described herein with reference to other figures. In addition, features and components of other devices described herein with reference to other figures can be included, either alone or in combination, with the devices described with reference to FIGS. 8-13.

As noted above, in particular with reference to device 500 shown in FIG. 5, any of the devices described herein can include one or more proximity sensors. One or more proximity sensors of devices described herein can include one or more proximity sensing modules or proximity stacks, such as, for example, Bluetooth modules, multiplexing Bluetooth modules, or ultra wideband (UWB) stacks, which can be configured to sense or detect a presence of another electronic device. For example, proximity sensors of devices (charging cases) described herein can be configured to sense when the device (e.g., charging case) is near a mobile phone, tablet or other computer, or other mobile or wearable electronic devices such as electronic watches, smart glasses, or headphones.

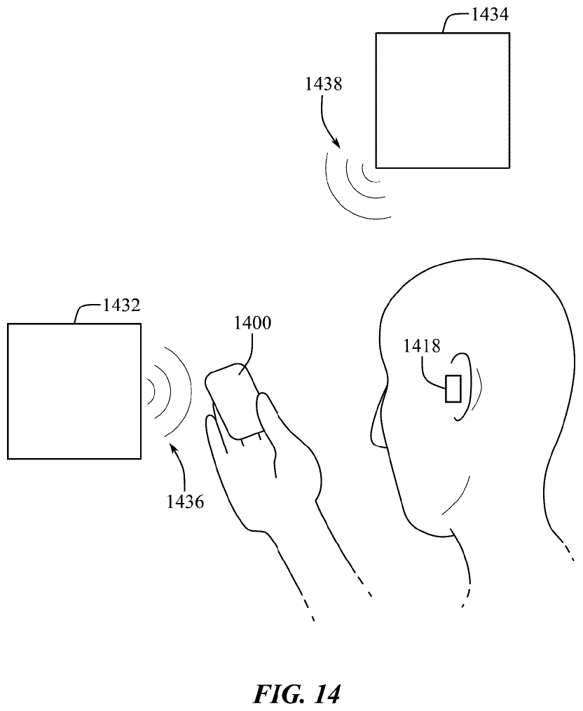

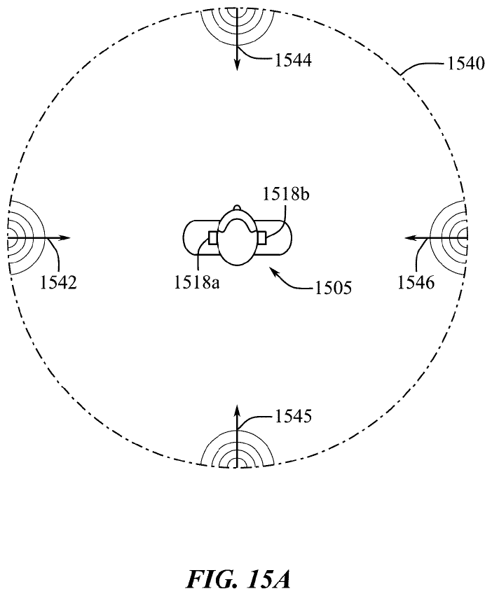

Along these lines, FIG. 14 shows a device 1400 in use within a proximity of other electronic devices. For purposes of clarity while describing FIG. 14, device 1400 is referred to as an earbud case or simply a case. During use, case 1400 can be brought into proximity with one or more other electronic devices, such as electronic devices 1432 and 1434. For purposes of clarity while describing FIG. 14, a non-limiting example of electronic device 1432 is a mobile phone and a non-limiting example of electronic device 1434 is a laptop computer.

Both mobile phone 1432 and laptop computer 1434 can output audio content to one or more earbuds 1418 worn by the user. As shown in FIG. 14, both mobile phone 1432 and laptop computer 1434 can transmit and receive signals, indicated by lines 1436 and 1438, respectively, between case 1400 and/or earbuds 1418. In one example, the signals 1436 and 1438 can include digitally transmitted audio content. In at least one example, signals 1436 and 1438 can include signals transmitted and received by one or more proximity sensors within mobile phone 1432 and laptop computer 1434. During use of case 1400 and earbuds 1418, the user may be receiving audio content from either mobile phone 1432 or laptop computer 1434. However, the user may also want to switch back and forth between audio content provided by the mobile phone 1432 and audio content provided by the laptop computer 1434.

Advantageously, as described herein with reference to other figures, case 1400 can include one or more proximity sensors configured to sense a presence of other electronic devices. For example, a proximity sensor of case 1400 can detect the presence of nearby mobile phone 1432 and laptop computer 1434. In addition, the one or more proximity sensors of case 1400 can be configured to sense a distance between case 1400 and other electronic devices. For example, as shown in FIG. 14, the user holds case 1400 closer to mobile phone 1432 than laptop computer 1434. In at least one example, one or more processors of case 1400 can be electrically connected to the one or more proximity sensors thereof, and can be configured to determine which external electronic device, mobile phone 1432 or laptop computer 1434, is closer to case 1400.

Once the relative position between case 1400 and either mobile phone 1432 or laptop computer 1434 is determined, case 1400 can be configured to provide the user with an option to receive the audio output of the nearest electronic device, which in the example illustrated in FIG. 14 includes mobile phone 1432. For example, once the user brings case 1400 into close proximity with a mobile phone 1432, a user interface region of case 1400, such as user interface regions described herein with reference to other figures and devices, can receive a touch or gesture command from the user indicating that the user wants to switch from one audio output source to another, for example from an audio output signal 1438 of laptop computer 1434, to the output source or signal 1436 of mobile phone 1432.

In another example, when the user brings case 1402 into closer proximity with laptop computer 1434, and thus further away from mobile phone 1432, the user can have an option to switch audio content being streamed to earbuds 1418 from the mobile phone 1432 audio output signal 1436 to the audio output signal 1438 of laptop computer 1434. Again, case 1400 can include one or more proximity sensors and processors that enable the detection of, and relative position with, external electronic devices. The one or more processors can cause case 1400 to switch the audio content that is transmitted to earbuds 1418 based on that relative position and one or more commands given by the user to case 1400 via one or more user interface regions of case 1400.

FIG. 14 shows a simple example of case 1400 providing the user with an easy and convenient way to switch audio content streamed to earbuds 1418 from one device to another, for example, from mobile phone 1432 to laptop computer 1434. One will appreciate that case 1400 can be configured with proximity sensors, processors, and other components that enable the user to switch from between more than two devices based on a proximity of case 1400. For example, a proximity or relative position of case 1400 and an electronic device disposed within the user's environment that provide an audio output, for example smart speakers, televisions, desktop computers, laptop and tablet computers, electronic watches, electronic glasses, or any other electronic device that outputs audio content within a home, office, or other environment, can be detected. As the user moves about his or her environment and becomes closer or further away from these other electronic devices, the user can seamlessly and conveniently choose which audio output to transmit to his or her earbuds by bringing the charging case of the earbuds into close proximity with a chosen electronic device, and gesturing or otherwise touching at a user interface region of the charging case to select the audio output of that electronic device.

As described above, when the user switches from the transmission of one audio content to another, the processor of devices described herein, such as earbud charging cases, can cause a smooth transmission from one audio source to the other as heard by the user through the earbuds. Such a transition can include a fading in and out between different audio sources. In one example, one audio source may be transitioned to the listener at a lower volume than the other. In another example, the volume of one audio source can be decreased but not completely removed when another audio source is provided. For example, notifications from other devices regarding text messages, e-mails, calendar events, and so forth, can slowly fade in to audibly overlay an audio track already being listened to while that audio track is reduced in volume or faded out.

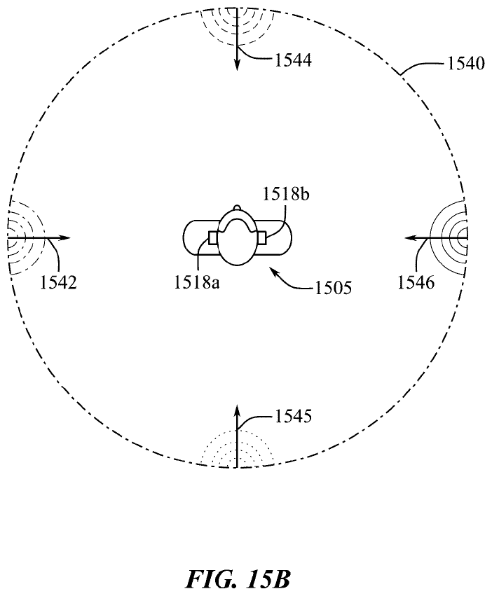

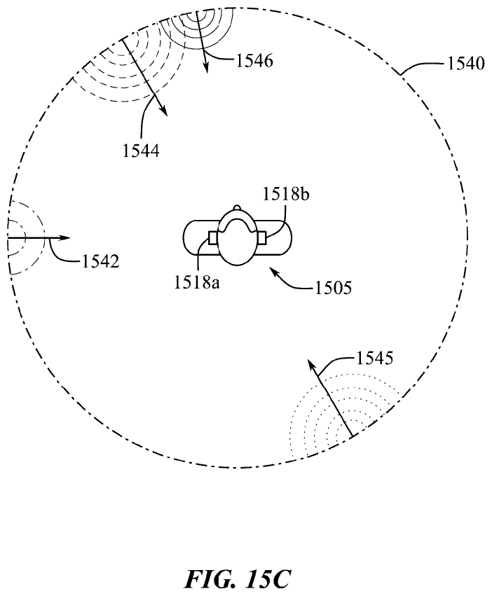

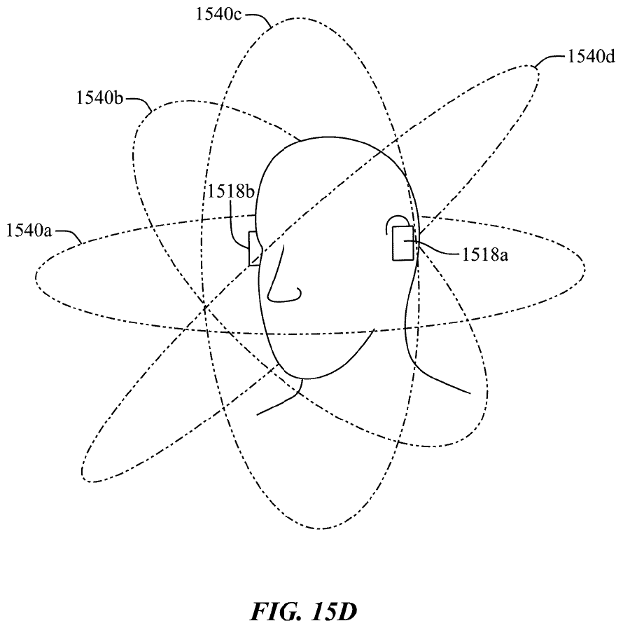

In addition to the fading or volume transitions between audio sources, charging cases, and devices described herein can cause earbuds worn by a user to produce and change the spatial location of the various audio content and sources provided to the user. FIG. 15A illustrates an example of a spatial audio system that includes two earbuds 1518a, 1518ba, 1518b with each earbud 1518 located in or at respective cars of the user 1505, as shown from a top view. In one example, by tracking head location and orientation, and correspondingly varying the audio output volume, timing or other features of the audio content output by earbuds 1518ba, 1518b from one earbud to the other, the perceived location, direction, and distance of audio content being listened to by the user can be manipulated from left to right, front to back, or above and below the user 1505. Spatial audio band 1540 represents a set of locations from which audio output of earbuds 1518a, 1518b can be perceived, but not necessarily from where sounds are generated. The sounds 1542, 1544, 1545, and 1546 can be produced at the location of the earbuds 1518a, 1518b such that the perceptions of those sounds 1542, 1544, 1545, and 1546 are located along the spatial audio band 1540, as shown in FIG. 15B. Sounds 1542, 1544, 1545, and 1546 are represented by directional arrows and sound propagation waves/lines. FIG. 15A shows four representative examples sounds 1542, 1544, 1545, and 1546 having specific locations and directions of audio content from earbuds 1518a, 1518b as perceived by the user. Perceived sounds 1542, 1544, 1545, and 1546 are given as non-limiting examples only. However, one or more other examples include a spatial audio system that can generate a perceived location of the output of earbuds 1518a, 1518b from any point along continuous locations and directions represented by band 1540.

In the example shown in FIG. 15A, each sound 1542, 1544, 1545, and 1546 may be the same output from both earbuds 1518a, 1518b such that the user perceives the audio output as if the user was in a central location surrounded by the sound 1542, 1544, 1545, and 1546. Alternatively, in at least one example shown in FIG. 15B, each sound 1542, 1544, 1545, and 1546 can be a unique input from one or both earbuds 1518a, 1518b, as indicated by each sound 1542, 1544, 1545, and 1546 having a different dotted line in FIG. 15B. In such an example, a user can perceive multiple sounds 1542, 1544, 1545, and 1546 from different directions as if, for example, the user was in a room with multiple sound sources coming from different directions, such as music from the left, a person talking from the right, another person talking in front of the user, and a car honking outside from behind. In this way, as shown in the example of FIG. 15B, spatial audio can be used to mimic a natural, real world acoustic environment with audio from the earbuds 1518a, 1518b.

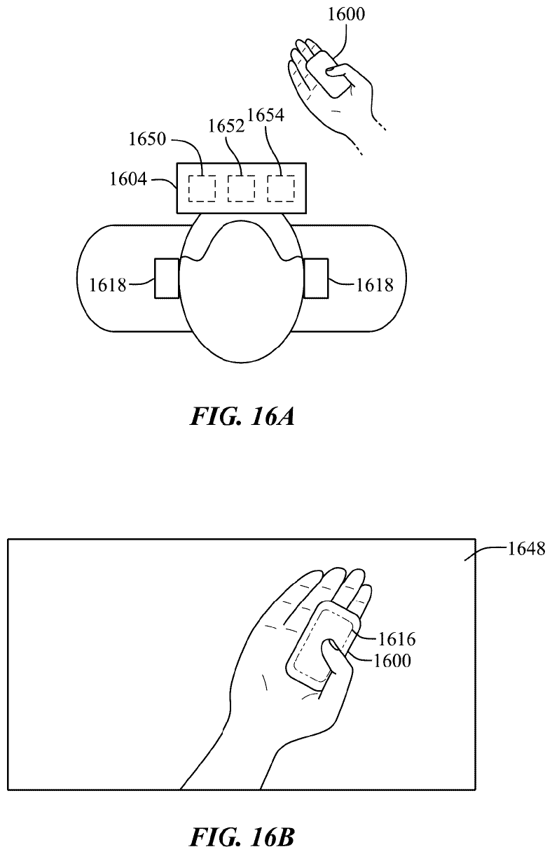

In at least one example, when switching from one audio source to another, the one or more processors of a charging case of earbuds 1518a, 1518b can cause earbuds 1518a, 1518b to change a perceived location or direction of the two or more different audio sources as the user transitions from one source to the other, as commanded by the user at a user interface region of the charging case. For example, if a user is listening to music and wants to switch from one track of music to another, the user can manipulate an interface surface (such as a swipe left to right on the user interface region of the charging case). Accordingly, one or more processors of the charging case can cause the earbuds to move the first track from left to right along spatial audio band 1540, as perceived by the user, and move the second track onto spatial audio band 1540 from left to right. For example, as shown in FIG. 16C, sound 1546, which was perceived from the right of user 1505 in FIG. 15B, can be moved left along spatial audio band 1540. As the first track, for example sound 1546, moves from left or right, a processor of the charging case can also cause the first track to fade away.

Along these lines, one will also note that the sound propagation wave lines associated with sounds 1542, 1544, 1545, and 1546, shown in FIG. 15C, can vary in number to indicate a volume level of each sound 1542, 1544, 1545, and 1546. That is, sound 1542 includes only two propagation wave lines in FIG. 15C compared to four propagation wave lines of sound 1542 as shown in FIG. 15B. Conversely, sound 1544 of FIG. 15C can be increased in volume compared to sound 1544 shown in FIG. 15B. The volume of each sound 1542, 1544, 1545, and 1546 may change the perceived distance from which the sound 1542, 1544, 1545, and 1546 is emanating. Thus, while spatial audio band 1540 is shown surrounding user 1505 at a certain distance, in at least one example, the distance of spatial audio band 1540 and the perceived distance of each sound 1542, 1544, 1545, and 1546 can also be varied.

The perceived positions of each sound 1542, 1544, 1545, and 1546 can be changed, in combination with the volume of each sound 1542, 1544, 1545, and 1546, as shown in FIG. 15C, such that input commands at the user interface region of the charging case of earbuds 1518a, 1518b can produce a dynamic, immersive, and natural sound experience. In addition, as shown in FIG. 15C, sounds can be manipulated at the charging case so that one or more sounds 1542, 1544, 1545, and 1546 partially or entirely overlap. This can be seen in FIG. 15C with sounds 1544 and 1546 moved to partially overlap. In such an example, user 1505 may perceive two sounds 1544, 1546 from the same or similar location along spatial audio band 1540.

The foregoing is one non-limiting example of how user touch and finger gesture commands at user interface region of an earbud charging case can be used to manipulate a spatial perception of audio content listened to through earbuds 1518a, 1518b. One will appreciate that any number of other swipes and/or gesture inputs by the user at the user interface region of an earbud charging case can manipulate the audio spatial perception of the audio output at earbuds 1518a, 1518b. For example, swiping right to left can move the perceived location of audio outputs from right to left or front to back on spatial audio band 1540. Transitions from one source of audio content to another, for example, as the user switches from audio content transmitted by one or more other devices as described above, can be spatially expressed as shown in FIGS. 15A-C. In this way, a gesture applied in a certain direction along the capacitive touch surface of the devices described herein can correspond to a perceived source location of the audio content output by the earbuds 1518a, 1518b. In this way, in at least one example, devices of the present disclosure can detect signals, either via user input gestures or other devices, and send instructions to one or more earbuds that corresponds to the input gesture or other signals and commands in order to alter a perceived location or source of the audio content.

For example, if the user is listening to music through the earbuds and receives a notification from an output feature of the control case, for example, a text message notification, the user can swipe or gesture at the user interface region of the charging case to indicate a desire to listen to an audio output of the text message. In one example, referring to FIG. 15A, the music being listened to may be spatially perceived from the location of sound 1544 of spatial audio band 1540. When the one or more processors of the charging case causes the text message audio content to be transmitted to earbuds 1518a, 1518b, for example, from a mobile phone source, the processor of the charging case can cause an audible reading of the text message to be transmitted to one or more of the earbuds 1518a, 1518b such that the text message audio content is spatially perceived by the user as coming from the right side, for example, sound 1546 on spatial audio band 1540. In addition, the text message audio content can gradually fade in and/or the music being listened to can fade out or be reduced in volume so that the text message audio content can be heard. In addition, as the text message audio content of sound 1546 fades in, the music being listened at sound 1544 can move to the left, for example, as shown in FIG. 15C.

In at least one example, using the devices and charging cases having processors and antennas described herein, multiple audio contents from multiple electronic devices having audio outputs can be simultaneously transmitted to earbuds 1518a, 1518b to be heard by the user. In such an example, one audio source can be spatially perceived at sound 1542, another audio source can be perceived at sound 1544, and another audio content can be perceived at sound 1546. In this way, multiple sources and audio contents can be perceived simultaneously as if they are coming from different directions along spatial band 1540, as shown in FIGS. 15B and 15C. In other examples, any number of audio sources and sounds can be simultaneously transmitted to earbuds 1518a, 1518b, with the sound outputs of each audio source being perceived at any number of spatial locations indicated by spatial audio band 1540.

As noted above, spatial audio band 5140 represents a continuous set of locations from which various sounds 1542, 1544, 1545, and 1546 can be perceived. However, by varying the volume and other characteristics of the sounds output through earbuds 1518a, 1518b, spatial audio band 1540 can be perceived from further away or closer away from what it shown in FIGS. 15A-C. In addition, as also noted above, the source of sounds 1542, 1544, 1545, and 1546 output from earbuds 1518a, 1518b can be perceived by the user 1505 as emanating front to back, left to right, top to bottom, or any combination. For example, as shown in FIG. 15D, sounds 1542, 1544, 1545, and 1546 shown in FIGS. 15A-15C can be perceived as originating along any number of three-dimensional spatial audio bands 1540a, 1540b, 1540c, and 1540d, or other bands not shown but positioned there between. In fact, user input commands including gestures and touches at the user interface regions of charging cases and devices described herein can be utilized to move the perceived source of sounds from earbuds 1518a, 1518b anywhere around the user in any direction and at any distance, as represented by spatial audio bands 1540a, 1540b, 1540c, and 1540d shown in FIG. 15D.

In this way, charging cases described herein can cause the user to experience multiple audio sources and contents as if they were in a room, for example, with multiple people talking or multiple devices providing audio outputs from different directions. In some examples, devices and systems described herein can mimic real world audio environments where the user perceives different audio content from different locations and can pay attention to what he or she chooses.

In at least one example, the various sensors and spatial audio manipulation functionalities of devices described herein, such as earbud charging cases, can be utilized within an augmented reality (AR) or virtual reality (VR) environment. Such an example is shown in FIGS. 16A and 16B. An AR/VR device 1604, such as the head-mounted device shown, can include one or more sensors for identifying device 1600, such as an earbud charging case. Once device 1600 is detected and located by AR/VR device 1604, a virtual representation of the user interface region 1616 of device 1600 can be displayed to the user through a display 1648 of the AR/VR device 1604. In such an example, the virtual representation of the user interface region 16 of device 1600 corresponds to the external surface of device 1600 that is configured to receive touch input commands from the user. In at least one example, this same region of the external surface of device 1600 may not be visible when not using AR/VR device 1604. In another example, this region of the external surface of device 1600 may still be visible when not using AR/VR device 1604.

Alternatively, or additionally, the external area of device 1600 on which virtual representation of user interface 16 is presented to the user through display 1648 of AR/VR device 1604 is not actually configured to receive gesture commands from the user. In such an example, AR/VR device 1604 can include a processor, circuitry, and sensors configured to visually detect the gestures performed by the user at the virtual representation of the user interface region 16 on the device 1600. Then, the processor and other components of AR/VR device 1604, including one or more antennas, can communicate the command and perform the associated function at connected earbuds 1618.

In one example, a gaze detection capability of AR/VR device 1604, which can include a head-mounted device, can be used in conjunction with the spatial audio manipulation of devices described herein. For example, as the users gaze switches from one thing to another within an AR/VR environment, devices described herein can spatially manipulate the audio outputs from earbuds to match the user's gaze within the AR/VR environment. Advantageously, this can create more immersive and realistic AR/VR experience for the user.

In addition to the various features, components, and advantages of devices described herein, in at least one example, a device can include one or more microphones configured to receive user commands from the user. In such examples, one or more processors of the device can be configured to detect or recognize speech of the user through the one or more microphones. Speech or other audio commands can be used in conjunction with, or separately from, the touch gestures input at the user interface regions of charging cases and devices described herein.

Additionally or alternatively to examples of devices and charging cases described herein, one or more devices can include one or more sensors including fitness or biometric sensors. Such sensors can be incorporated within the housing of devices described herein to track biometric data or fitness data of the user. For example, as a user holds an earbud charging case in his or her pocket, one or more sensors of the charging case can detect the number of steps taken by the user, a temperature of the user, or other fitness and biometric data. The one or more processors of the charging case device can cause the charging case device to relay the sensed or detected biometric and fitness data to the user via one or more output features as described herein. Additionally or alternatively, the charging case device can be configured to transmit audio information containing the fitness and biometric data sensed or detected by the sensors to the earbuds.

One or more other sensors can be included in one or more other examples of devices described herein. For example, one or more environmental sensing sensors can be included in a device such as an earbud charging case. Environmental sensors can include sensors configured to detect or sense other objects, electronic devices, or people within the environment or other environmental characteristics. In one example, one or more sensors can sense the temperature, humidity, or other physical characteristics of the environment and relay such information to the user through the earbuds wirelessly connected to charging case device or via one or more visual or tactile output features of the device. In examples where one or more sensors are configured to detect other objects or people within an environment, one or more processors of the charging case device can be configured to cause audio content relating to those other objects, devices, or people, to be transmitted to the user through the earbuds.

Additionally or alternatively to examples of devices and charging cases described herein, one or more devices can include one or more memory components, as discussed above, so that the device is configured as a stand-alone radio or music playlist device. Furthermore, one or more examples of devices described herein can include one or more wireless internet connection components or modules configured to connect the device to the internet for streaming audio content.

In at least one example of the devices described herein, such as earbud charging case devices described herein, multiple people can receive the transmission of audio content from the same device, for example a television or mobile phone, with each users charging case adapting the audio content to the user's needs. This can be done either automatically or by command from the user via at least the user interface region of the charging case. For example, if two or more people are watching and listening to a television through their respective earbuds, each user can uniquely adapt the audio output to their needs. For example, some users may need or want the volume to be louder or softer. Also for example, some users may prefer turning up the bass or treble components of the audio output. Advantageously, each user utilizing the devices described herein can change the audio output to meet their own needs without affecting the audio output transmitted to others. This can have unique and advantageous accessibility implications for providing altered or enhanced audio experiences to those with hearing impairments or other hearing disabilities.

In some examples, personal information data can be gathered with the present systems and methods, which personal information should be gathered pursuant to authorized and well established secure privacy policies and practices that are appropriate for the type of data collected. Such personal information can be used to practice and improve on the various examples described herein. The disclosed technology is not, however, rendered inoperable in the absence of such personal information data.

It will be understood that the various details of the present systems and methods provided above can be combined in various combinations and with alternative components. The foregoing descriptions of the specific examples described herein are presented for purposes of illustration and description. They are not intended to be exhaustive or to limit the embodiments to the precise forms disclosed. Rather, many modifications and variations are possible in view of the above teachings.

What is claimed is:

1. An electronic device, comprising:
a housing having a cavity configured to receive an earbud;
an input device configured to generate a signal in response to detecting a user input; and
circuitry coupled to the input device and configured to:
detect the signal; and
in response to detecting the signal, send an instruction to the earbud to change at least one of a source or a perceived location of audio content output at the earbud.

2. The electronic device of claim 1, wherein the input device is further configured to generate a graphical user interface.

3. The electronic device of claim 2, wherein:
the graphical user interface includes a user selectable icon corresponding to an audio source; and
the audio source includes at least one of a music application, a calendar application, an email application, a message application, or a weather application.

4. The electronic device of claim 1, wherein the input device comprises a capacitive touch surface.

5. The electronic device of claim 4, wherein the user input comprises a gesture applied in a direction along the capacitive touch surface.

6. The electronic device of claim 5, wherein:
in response to detecting the signal, the input device sends an instruction to the earbud to change the perceived location of audio content output at the earbud; and
the direction corresponds to a perceived source location of the audio content.

7. The electronic device of claim 5, wherein the instruction changes the perceived source location.

8. An electronic system, comprising:
a case defining an external surface and including a cavity configured to receive an electronic device; and
a display device configured to:
generate a first user interface at the external surface; and
in response to detecting a user input at the external surface, generate a second user interface.

9. The electronic system of claim 8, wherein the first user interface comprises a graphical user interface.

10. The electronic system of claim 9, wherein the first user interface comprises an audio user interface.

11. The electronic system of claim 9, wherein the first user interface comprises a virtual user interface.

12. The electronic system of claim 9, wherein:
the case includes a capacitive touch surface at least partially defining a user interface region of the external surface; and
the electronic device comprises an earbud.

13. The electronic system of claim 12, wherein the user input comprises a gesture input.

14. The electronic system of claim 13, wherein the gesture input includes a touch input at the capacitive touch surface.

15. The electronic system of claim 14, wherein:
the touch input contacts the capacitive touch surface at a location corresponding to a user selectable icon of the first user interface; and
the second user interface comprises a second user selectable icon.

16. A head mountable display, comprising:
a processor;
memory; and
a program stored in the memory, the program including instructions which, when executed by the processor, cause the head mountable display to:
display a virtual user interface on an external surface of a housing of an electronic device defining a cavity;
detect a user input at the external surface while displaying the virtual user interface; and
in response to detecting the input, alter the virtual user interface.

17. The head mountable display of claim 16, wherein the virtual user interface corresponds virtually to a user interface region defined by the external surface of the electronic device.

18. The head mountable display of claim 17, wherein the user interface region of the external surface comprises a capacitive touch surface.

19. The head mountable display of claim 18, wherein:
displaying the virtual user interface comprises displaying a first user selectable icon; and
altering the virtual user interface comprises displaying a second user selectable icon.

20. The head mountable display of claim 16, wherein the cavity is shaped to receive an earbud.
